(19) United States
(12) Patent Application Publication
(10) Pub. No.: US 2018/0217050 A1
(43) Pub. Date: Aug. 2, 2018

(54) INVASIVE ACTIVE DYNAMIC TESTS TO DETERMINE SURFACE COEFFICIENT OF FRICTION

(71) Applicant: GM GLOBAL TECHNOLOGY OPERATIONS LLC, Detroit, MI (US)

(72) Inventors: EDWARD T. HEIL, HOWELL, MI (US); ERIC E. KRUEGER, CHELSEA, MI (US); ROBERT L. NISONGER, MILFORD, MI (US); JOSHUA R. AUDEN, BRIGHTON, MI (US); PATRICK J. MONSERE, HIGHLAND, MI (US); Brandon C. Pennala, Howell, MI (US); Constandi J. Shami, Ann Arbor, MI (US)

(73) Assignee: GM GLOBAL TECHNOLOGY OPERATIONS LLC, Detroit, MI (US)

(21) Appl. No.: 15/420,004

(22) Filed: Jan. 30, 2017

(51) Int. Cl. G01N 19/02; B60T 8/172

(52) U.S. Cl. CPC G01N 19/02; B60T 2210/12; B60T 8/172

(57) ABSTRACT

A method for testing to determine a coefficient of friction between a vehicle wheel and a surface with which the vehicle wheel is in contact (“surface mu”) includes the steps of calculating a surface mu confidence level based upon an evaluation of a locale of interest, an evaluation of visual cues sensed by the vehicle at the locale of interest, and/or an evaluation of vehicle signals at the locale of interest and scheduling the vehicle to perform active dynamic testing at the locale of interest. The method further includes the steps of performing the active dynamic testing, wherein the testing comprises commanding the vehicle to perform one or more of propulsion torqueing, regenerative torqueing, or brake torqueing of at least one wheel of the vehicle, receiving a measured parameter from the at least one wheel during said testing, and calculating a surface mu value for the locale of interest.

### INTRODUCTION

The present disclosure generally relates to vehicle systems and operations. More particularly, the present disclosure relates to systems and methodologies for the determination of a coefficient of friction (mu) between one or more vehicle tires and a surface over which the vehicle is travelling.

Various forces applied to a vehicle during a maneuver are transmitted through its tires. Therefore, knowledge of the capacity of the tire to transmit forces between the tire and road at any instant, under changing road conditions (e.g., weather, road material, etc.), is required in order to improve the performance of a vehicle control system. This is particularly true, given the vehicle manufacturing industry's increasing interest in autonomous vehicle control systems, which, in order to maintain safety, need to comprehend possible changes to the environment away from ideal. Estimation and/or positive determination of the instantaneous maximum coefficient of friction for the current road conditions is therefore desirable to enable a higher awareness of the environmental conditions, as well as to enable the performance of the vehicle to be better optimized for varying road conditions.

Accordingly, it is desirable to provide improved systems and methodologies to determine the coefficient of friction between vehicle tires and the surface over which the vehicle is travelling. Furthermore, other desirable features and characteristics of the present disclosure will become apparent from the subsequent detailed description and the appended claims, taken in conjunction with the accompanying drawings and this introductory section.

### BRIEF SUMMARY

A method for active dynamic testing to determine a coefficient of friction between a vehicle wheel and a surface with which the vehicle wheel is in contact (“surface mu”) includes the step of: calculating a surface mu confidence level based upon an evaluation of a locale of interest for surface mu determination and at least one of: an evaluation of visual cues sensed by the vehicle at the locale of interest and an evaluation of vehicle signals at the locale of interest. Based upon a calculated relatively low surface mu confidence level, the method further includes the step of scheduling the vehicle to perform active dynamic testing at the locale of interest. Based upon the scheduling, the method further includes the steps of performing the active dynamic testing, wherein the testing comprises commanding the vehicle to perform one or more of propulsion torqueing, regenerative torqueing, or brake torqueing of at least one wheel of the vehicle and receiving at least one measured parameter from the at least one wheel during said testing. Still further, based on the at least one measured parameter, the method includes the step of calculating a surface mu value for the locale of interest.

### BRIEF DESCRIPTION OF THE DRAWINGS

The present disclosure will hereinafter be described in conjunction with the following drawing figures, wherein like numerals denote like elements, and wherein:

FIG. 1 is a method flow diagram of a method provided in accordance with some embodiments of the present disclosure;

FIG. 2 illustrates a three-dimensional graph of estimated surface friction as a function of outside air temperature and rain intensity or wiper duty cycle;

FIG. 3 illustrates a method for the use of outside air temperature data and wiper activity data or rain sensor data as part of a determination to conduct active testing;

FIG. 4 illustrates a negative torque/regenerative testing procedure;

FIG. 5 illustrates a positive torque testing procedure from vehicle standstill;

FIG. 6 illustrates a positive torque testing procedure from vehicle standstill with non-driven wheel brakes applied;

FIG. 7 illustrates a positive torque testing procedure while the vehicle is in motion;

FIG. 8 is a method flow diagram of a method for the positive torque testing procedures illustrated in FIGS. 4-7;

FIG. 9A illustrates the relationship between brake torque and wheel slip, while FIG. 9B illustrates the relationship between brake pressure and actual surface mu, in the context of brake torque testing;

FIG. 10 is a method flow diagram of a method for brake torque testing;

FIG. 11 is a system diagram of an autonomous vehicle control system; and

FIG. 12 is an illustration pertaining to the measurement and calculation of coefficient of friction based on applied and measured variables.

### DETAILED DESCRIPTION

The following detailed description is merely exemplary in nature and is not intended to limit the disclosure or the application and uses of the disclosed systems and methods. Furthermore, there is no intention to be bound by any theory presented in the preceding introductory section or the following detailed description.

The present disclosure generally provides invasive active dynamic testing methodologies (and associated systems) to determine a surface coefficient of friction in the context of a vehicle tires travelling over the surface. In this disclosure, a heuristic algorithm is employed to estimate a road surface coefficient of friction based on various methods, as will be described in greater detail below, and to determine a confidence level for these estimates. When the confidence is sufficiently low, and when, during the travel of the vehicle, it is safe and it is opportune to do so, an invasive active dynamic test is requested from the vehicle control system with the goal to positively determine the road surface coefficient of friction (mu) estimate. The invasive active dynamic testing, when requested, may use the steering and/or brake system actuators to apply a specific controlled force disturbance to the tire/road contact patch. By observing the reactions of the wheel and vehicle system to this applied force by measured signals, an estimate of surface mu can be determined. Accordingly, as opposed to being completely reactive to actual road surface mu, this disclosure uses a proactive approach to determine the road surface mu.

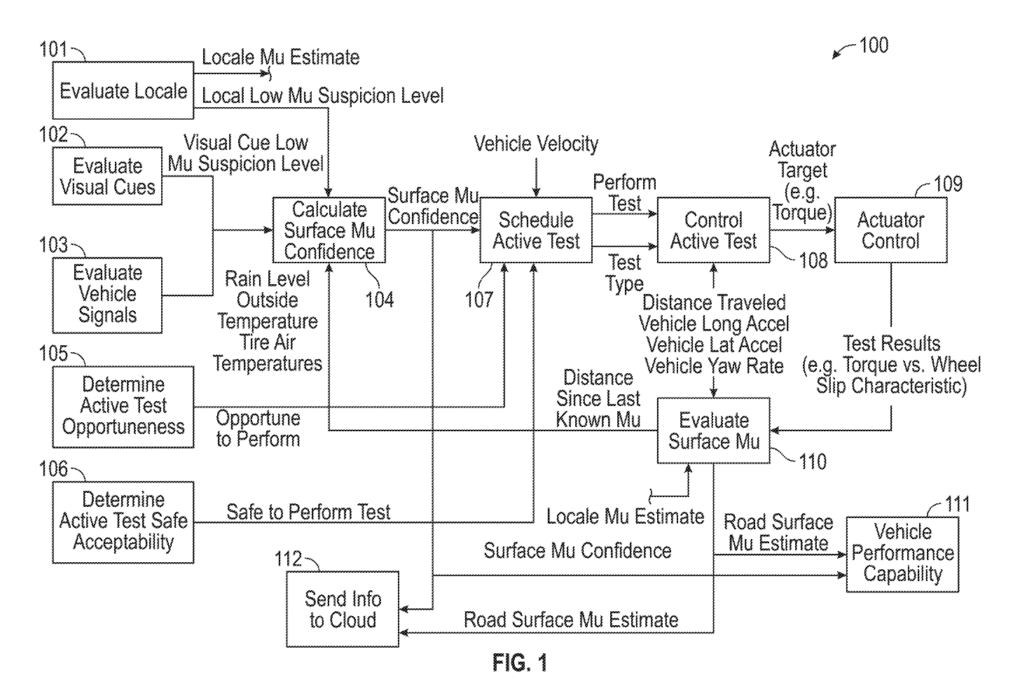

FIG. 1 is a method flow diagram of a method 100 provided in accordance with some embodiments of the present disclosure. Blocks 101, 102, and 103 are mu estimation blocks, and provide an initial source of information upon which the system generates an initial mu estimate for a particular locale. At block 101, the system evaluates the locale. A first aspect of locale evaluation is preparation for an event where surface mu confirmation may be needed, such as a highway exit ramp, or other surface feature where the surface mu is of particular interest to the safe operation of the vehicle. Such preparation may be initiated upon the determination that a surface feature is present along the vehicles intended route of travel, which is determined from road surface databases and the like. A second aspect of the locale evaluation is usage of information from “cloud”-type data storage systems that are remotely accessible. It may be the case that the vehicle in question is part of a fleet of other vehicles, such as autonomous vehicles. It may further be the case that other vehicles in the fleet have experience low surface mu conditions in nearby locations in the recent past. Thus, in such cases, the vehicle in question is able to remotely access and obtain this information from the cloud-type data storage system. For example, when there is confidence in information obtain from the fleet, the locate mu estimate may be adjusted accordingly. However, where there is insufficient fleet data, or a long period of time has passes since the most recent fleet data was obtained, the suspicion of a low mu surface may be reduced. Other uses of cloud-type data include weather forecast changes, which may be a cause for a change in surface mu suspicion. A third aspect of the locale evaluation is the use of locale information in combination with weather suspicions. For example, surfaces such as parking lots and bridge, during cold and wet weather conditions, may be suspected to have a low surface mu. A fourth aspect of the locale evaluation is the use of locale information based on road surface estimations due to a past history of travelling on the surface or a known road type from mapping data. For example, gravel roads or rough roads, known from prior travels or mapping data, may be suspect to have a lower surface mu.

At block 102, the system evaluates visual cues. Autonomous vehicles typically include visual sensors of various kinds, such as cameras, to aide in the safe operation of the vehicle. In the context of the evaluation block 102, these visual sensors may be employed to evaluate the suspicion of a reduced or low surface mu. For example, a visual cue may lead to a suspicion of a low surface mu value when rain, ice, or snow is detected due to obstruction of the sensor (e.g., causing a sensor cleaning request). In another example, such suspicion may be present when the visual sensor detects that the road surface has become white, which may be an assumption of layer of snow on the surface. In yet another example, such suspicion may be present when the visual sensor detect that the road surface has become shiny, which may be an assumption of a layer of ice on the surface.

At block 103, the system evaluates vehicle signals. Various vehicle systems may be associated with lower surface mu conditions. For example, a vehicle signal may include a rain detection sensor and/or activation of the windshield wipers. In another example, a vehicle signal may include the detection of the outside air temperature and/or the outside humidity. In yet another example, a vehicle signal may include tire air temperatures. Each of these signals may be appropriately used to deduce the present of atmospheric conditions that may indicate a suspicion of lower surface mu conditions.

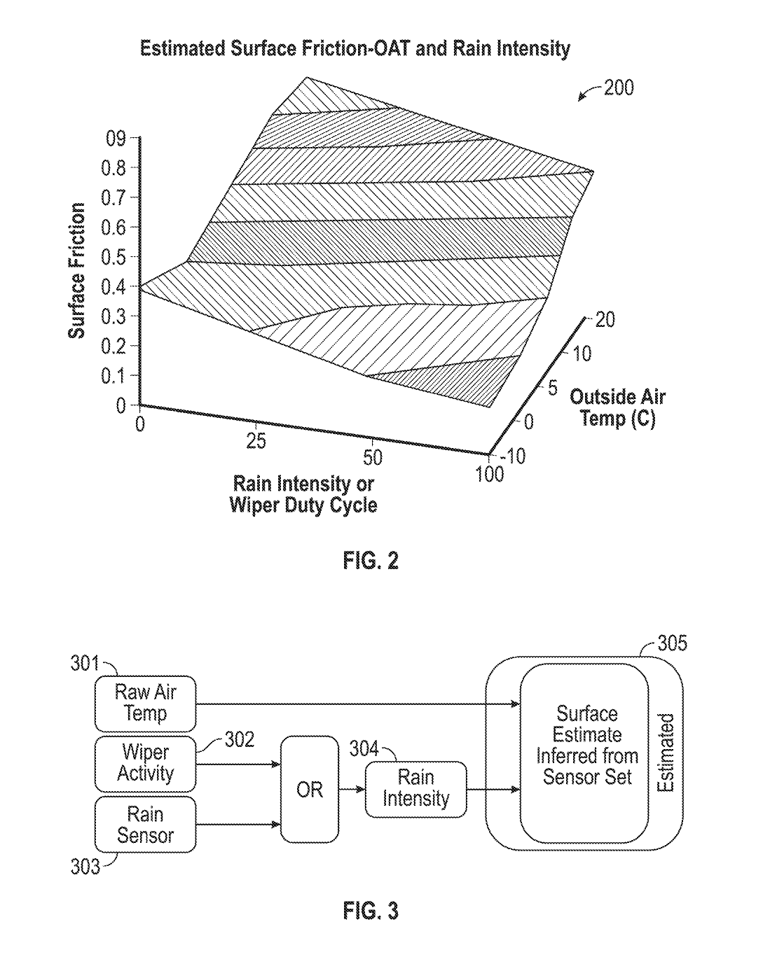

A further aspect of the present disclosure is the inference of road surface friction by monitoring rain intensity and outside air temperature. When raining and warm, the surface is assumed to be of a moderate friction level. When raining/wet and cold, the surface friction is assumed to be low. This further aspect of the disclosure fuses the data from rain and outside air temperature sensors on a vehicle to predict road surface friction. If a rain sensor is not available, the rain intensity can be determined from windshield wiper activity. For example, FIG. 2 illustrates a three-dimensional graph 200 of estimated surface friction as a function of outside air temperature and rain intensity or wiper duty cycle. This graph is provided to illustrate one hypothetical relationship, whereas the actual relationship among the variables will need to be determined for a particular vehicle type in practical use. The logic can also be used to determine when to conduct active testing of surface friction via brake, propulsion, or steering interventions. For example, FIG. 3 illustrates a method 300 for the use of outside air temperature data and wiper activity data or rain sensor data as part of a determination to conduct active testing. Block 301 represents an input of outside air temperature, block 302 represents windshield wiper activity, and block 303 represents the rain sensor. Rain intensity may be inferred at block 304 from either block 302 or block 303. At block 305, the rain intensity and temperature are fed through a lookup table (for example, in the form of the relationship shown in FIG. 2) to estimate road surface friction.

With continued reference to FIG. 1, based on the information obtained/determined at blocks 101-103, the system may calculate surface mu confidence at block 104. For example, the confidence in surface mu may be considered low when the following conditions are met. As a first condition, the vehicle should have traveled a large distance since the last positive determination of surface mu. This distance-traveled value may be determined based on system requirements. As a second condition, there should be a suspicion of a lower surface mu. Such suspicion may be met when there is a high suspicion of a low surface mu at the locale of interest based on, for example, block 101. Such suspicion may alternatively be met where there is an indication of a low mu from visual cues, for example as derived from block 102, and further that measured weather conditions, for example from block 103, plausibly suggest that a lower surface mu is possible.

As further illustrated in FIG. 1, blocks 105 and 106 determine the opportuneness and safeness of conducting an active coefficient of friction test by the vehicle. With reference to block 105, an active test may be considered opportune based on the following factors. First, it is typically more opportune to perform active invasive testing when there are no passengers travelling in the vehicle. Second, it should be understood that certain situations are more opportune for certain active tests (the types of test are discussed in greater detail below). Thus, a factor in opportuneness is the consideration of a particular test type as the optimal test for a particular situation.

With reference to block 106, an active test may be considered safe based on the following considerations, i.e., whether the following safety considerations are met. First, it should be determined that the intent of the autonomous drive system is to drive steadily, for example, with no large turns planned in the near future. Second, it should be determined that there is minimal traffic nearby, including the consideration of any cross-traffic or obstacles. Third, it should be determined that the distance to any vehicles in front or behind of the vehicle in question is sufficiently large, as may be determined based on system requirements. Fourth, it should be determined that vehicle velocity is within an acceptable range, again as may be determined based on system requirements.

A further aspect of the system shown in FIG. 1 is the scheduling of an active test at block 107, based on the confidence from block 104, the opportuneness from block 105, and the safety based on block 106. For example, an active test should be requested when the surface mu confidence is low and it is safe to perform the test. The particular type of test, whether a brake test, a propulsion torque test, a steering test at standstill, or other type of test, as will be discussed in greater detail below, may be decided considering current vehicle conditions and information about opportuneness.

With continued reference to FIG. 1, the active invasive testing, when requested, is controlled, performed, and evaluated in accordance with blocks 108, 109, and 110. First, with reference to block 108, control of the active test is exercised based on the type of test requested, e.g., from block 107. In general, testing may be performed based on any combination of vehicle commands, such as accelerations, regen, braking, and steering wheel turns. Based on these commands, testing measurements may be made as to any of wheel torque (propulsion, braking, regen), acceleration (both linear as to the vehicle and angular as to the wheels) velocity (both linear as to the vehicle and angular as to the wheels), yaw, various pressures and forces, etc. For a more complete understanding, various types of testing methodologies are presented as follows.

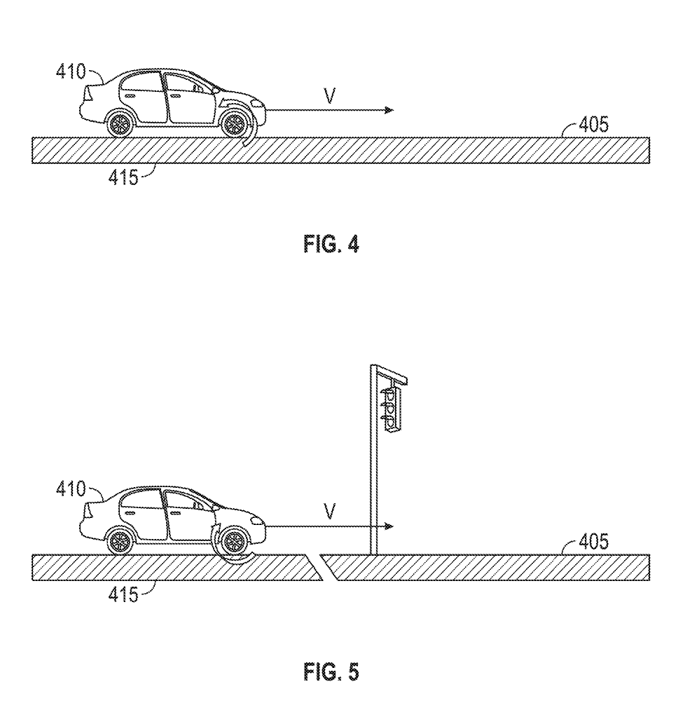

In one example, the active test may be a commanded propulsion torque test. In this test example, active surface mu measurement may be accomplished using a commanded propulsion torque that slowly ramps-up propulsion or regenerative torque until a set value is reached or until wheel slip is observed on the driven axle in order to measure the surface mu coefficient or infer that it is higher than the seeded value. The torque applied can be either positive (forward command) or negative (regenerative “regen” command). Thus, the purpose of actively commanding a propulsion torque ramp-up is to intentionally find the point at which the driven tires begin to slip, which will give an accurate measurement of the surface mu coefficient. Various examples of this type of active testing are provided below in connection with FIGS. 4-7.

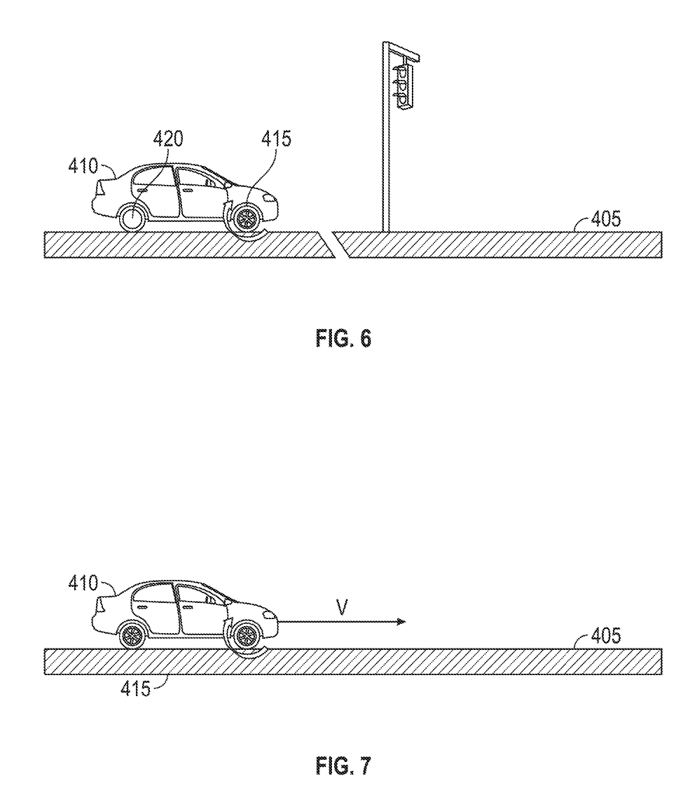

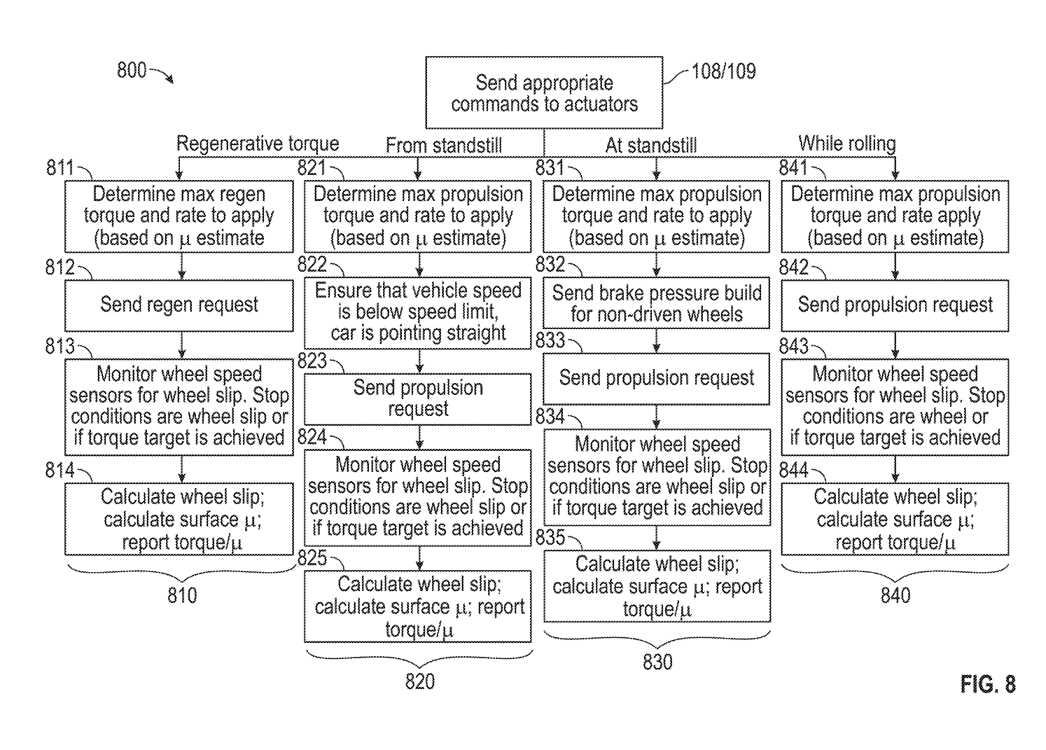

FIG. 4 illustrates a negative torque/regen testing procedure. FIG. 5 illustrates a positive torque testing procedure from vehicle standstill. FIG. 6 illustrates a positive torque testing procedure from vehicle standstill with non-driven wheel brakes applied. FIG. 7 illustrates a positive torque testing procedure while the vehicle is in motion. Further, FIG. 8 is a method flow diagram of a method 800 for the positive torque testing procedures illustrated in FIGS. 4-7. First, with reference to FIG. 4, a vehicle 410 is shown on surface 405 with its front wheels 415 in regen mode while in forward travel. In connection with FIG. 4, at column 810 of FIG. 8, and at block 811, the maximum regen torque and rate to apply is determined based on the previously-described surface mu estimate. At block 812, the regen request is sent to the vehicle control system, which will be discussed in greater detail below in connection with FIG. 11. At block 813, the system monitors wheel speed sensors for wheel slip. The testing is stopped if wheel slip is achieved or if the maximum regen torque target is achieved. Then, at block 814, wheel slip and surface mu are calculated and reported back to the surface mu estimation/testing system.

Second, with reference to FIG. 5, the vehicle 410 is shown on surface 405 with its front wheels 415 in a positive torque condition from standstill, with the intended direction of motion being forward. In connection with FIG. 5, at column 820 of FIG. 8, and at block 821, the maximum propulsion torque and rate to apply is determined based on the previously-described surface mu estimate. At block 822, it is ensured that the vehicle speed is below the speed limit (i.e., ideally at standstill) and that the vehicle is pointed straight ahead. At block 823, the propulsion request is sent to the vehicle control system. At block 824, the system monitors the wheel speed sensors for wheel slip. The testing is stop if wheel slip is achieved or if the maximum torque target is achieved. Then, at block 825, wheel slip and surface mu are calculated and reported back to the surface mu estimation/testing system.

Third, with reference to FIG. 6, the vehicle 410 is shown on surface 405 with its front wheels 415 in a positive torque condition from standstill and with the rear wheels 420 having their brakes applied, with the intended direction of motion being forward. In connection with FIG. 6, at column 830 of FIG. 8, and at block 831, the maximum propulsion torque and rate to apply is determined based on the previously-described surface mu estimate. At block 832, a request for brake pressure build-up is sent to the vehicle control system for the rear wheels 420. At block 833, the propulsion request is sent to the vehicle control system for the front wheels 415. At block 834, the system monitors the front wheel speed sensors for wheel slip. The testing is stop if wheel slip is achieved or if the maximum torque target is achieved. Then, at block 835, wheel slip and surface mu are calculated and reported back to the surface mu estimation/testing system.

Fourth, with reference to FIG. 7, the vehicle 410 is shown on surface 405 with its front wheels 415 in a positive torque condition while the vehicle is in forward motion. In connection with FIG. 7, at column 840 of FIG. 8, and at block 841, the maximum propulsion torque and rate to apply is determined based on the previously-described surface mu estimate. At block 842, the propulsion request is sent to the vehicle control system for the front wheels 415. At block 843, the system monitors the front wheel speed sensors for wheel slip. The testing is stop if wheel slip is achieved or if the maximum torque target is achieved. Then, at block 844, wheel slip and surface mu are calculated and reported back to the surface mu estimation/testing system.

In another example, as opposed to a commanded propulsion torque test, the active test may be a commanded brake torque test. In this test example, active surface mu measurement may be accomplished using a commanded propulsion torque that attempts to cause one of the rear wheels to generate wheel slip while the vehicle is in forward motion. If wheel slip is detected, the surface mu can be determined from the brake torque applied at the point of wheel slip. Accordingly, this testing method use an active measurement of road surface friction that only needs one wheel to be unstable, not two wheels or the entire vehicle. Further, the test can be run as needed and does not require the driver or autonomous system to perform a certain maneuver. Finally, the brake torque can be negated by applying positive propulsion torque such there is no deceleration disturbance.

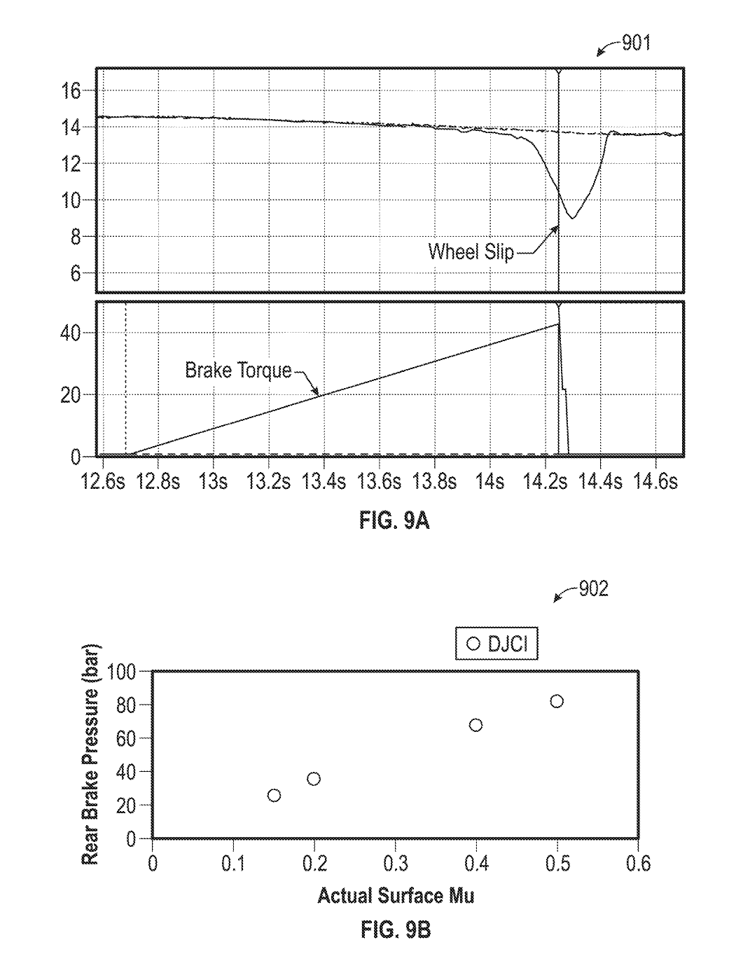

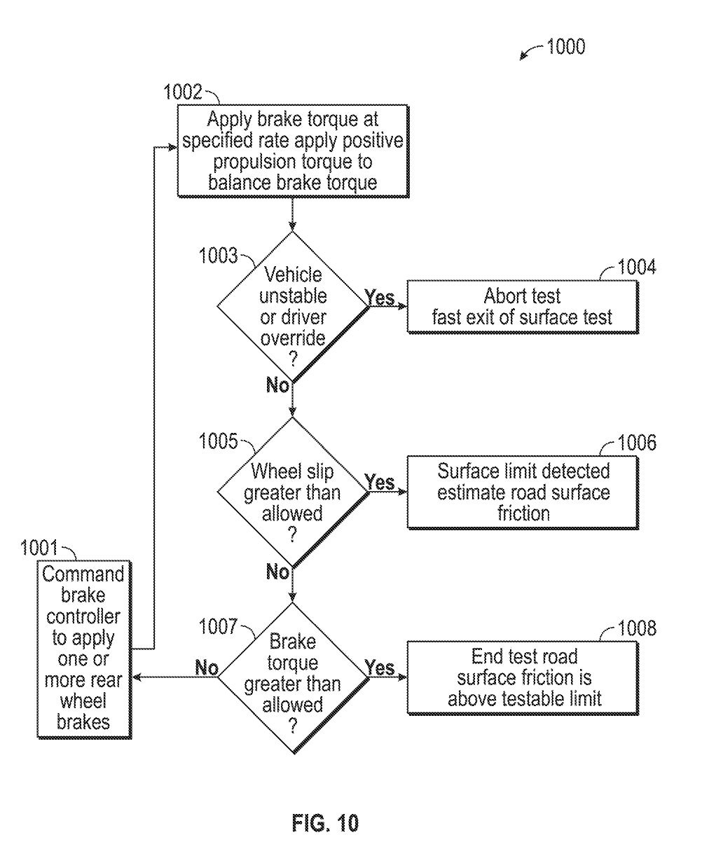

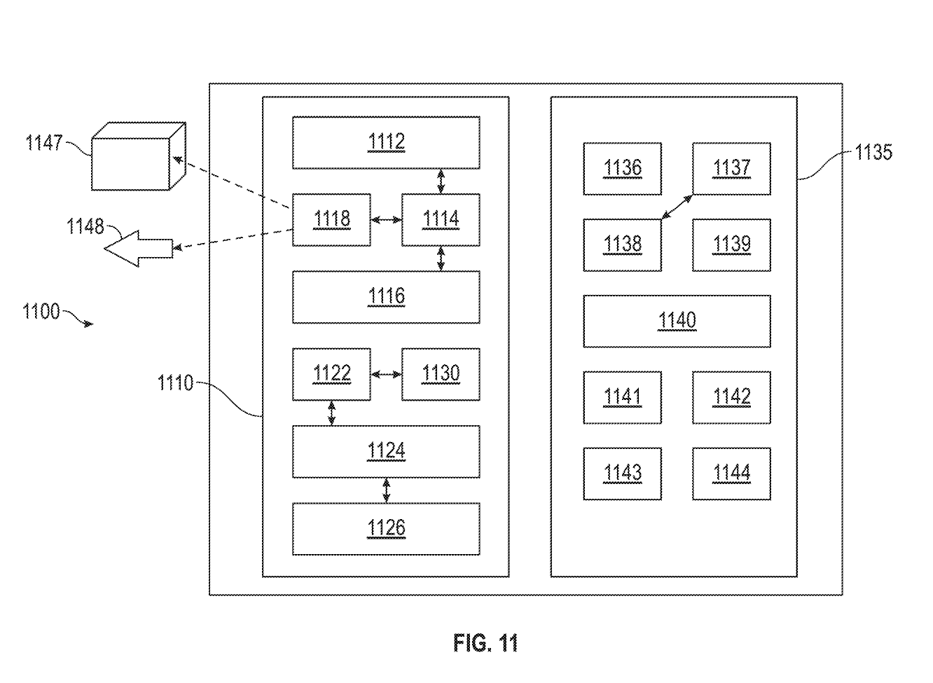

FIG. 9A illustrates the relationship between brake torque and wheel slip, while FIG. 9B illustrates the relationship between brake pressure and actual surface mu, in the context of brake torque testing. FIG. 10 is a method flow diagram of a method 1000 for brake torque testing. Turning first to FIGS. 9A and 9B, it should be appreciated that, as shown in graph 901 of FIG. 9A, that, for a wheel rotating at a fairly constant angular velocity, a braking wheel slip condition may be indicated by a sudden drop in angular velocity. To cause this wheel slip, brake torque may be steadily increased at the wheel in question until the wheel's grip of the surface is exceeded. Thus, as shown in FIG. 9B, graph 902, brake pressure applied at the wheel, which causes the brake torque, may be directly correlated with the wheel's grip of the surface, and therefore the surface mu.

Utilizing these principles, method 1000 shown in FIG. 10 begins at block 1001 with a command to the vehicle control system brake controller to apply one or more rear wheel brakes. At block 1002, brake torque is applied to the wheel(s) at a specified, increasing rate. It should be noted that additional positive propulsion torque may be required at the drive wheels in order to balance the brake torque and prevent the vehicle from slowing during the test. Thereafter, at block 1003, an initial determination is made whether the vehicle is unstable or whether a driver override has been received. If so, as indicated at block 1004, the test is immediately aborted. If the vehicle is stable and no override command is received from the driver, then as indicated at block 1005, a determination is made whether the wheel slip is greater than a predetermined maximum allowable limit. If so, at block 1006, the surface limit has been detected, and an estimation of surface mu may be made. If not, at block 1007, a further determination is made as to whether the brake torque is greater than a predetermined maximum allowable limit. Is so, at block 1008, the test is ended as the road surface friction is above the testable limit. If not, the increasing of the torque is continued until an affirmative determination is made at either block 1003, 1005, or 1007.

Returning back to FIG. 1, particularly block 109, which denotes the “actuator” control, it should be appreciated that in the foregoing discussion, the vehicle control system was reference in connection with propulsion commands, regen commands, and braking commands. As such, it should be appreciated that this vehicle control system may comprise, consist of, or otherwise be a part of an overall autonomous vehicle control system, as described further in connection with FIG. 11. More specifically, there is shown in FIG. 11 an embodiment of an autonomous vehicle 1100. The vehicle 1100 includes at least an autonomous operating system 1110 for movements the vehicle 1100. The autonomous operating system 1110 includes a steering module 1112 and a controller 1114 for controlling steerable wheels 1116 of the vehicle 1100. The operating system 1110 further includes a drive module 1122 and a controller 1124 for controlling transmission 1126 of the vehicle 1100. The steering module 1112 may be an electronic module or similar device that is capable of turning the steerable wheels 1116 without a driver's steering demand via a steering wheel of the vehicle. The controller 1114 provides control input signals to the steering module 1112, such as a conventional electronic power steering module, for controlling the turning of the steerable wheels during maneuvers. The controller 1114 may be separate from the steering module 1112 or may be integrated within the steering module 1112 as a single unit. The drive module 1122 may be an electronic module or similar device that is capable of engaging transmission 1126 in either the forward or reverse direction without a driver's demand via a transmission shift mechanism of the vehicle 1100. The controller 1124 provides control input signals to the drive module 1122, such as a conventional electronic drive module, for controlling the forward and reverse movements of the vehicle 1100 during a parking maneuver. The controller 1124 may be separate from the drive module 1122 or may be integrated within the drive module 1122 as a single unit.

The autonomous operating system 1110 further includes a sensing device 1118 for detecting objects 1147 and position marking indicators 1148 proximate to the driven vehicle. As used herein, the term “objects” refers to any three-dimensional object that may be an obstruction in the path of the vehicle 1100. As further used herein, the term “position marking indicator” refers to any symbology used to provide a reference position for the vehicle 1100, such as lane lines, arrows, numbers, and the like. The sensing device 1118 detects the presence and non-presence of objects 1147 and position marking indicators 1148 laterally from the vehicle for determining an appropriate path. The sensing device 1118 may include a radar-based sensing device, an ultrasonic-based sensing device, an imaging-based sensing device, or similar device capable of providing a signal characterizing the available space between the objects 1147 or with reference to position marking indicators 1148. The sensing device 1118 is in communication with the controller 1114 for providing signals to the controller 1114. The sensing device 1118 may be capable of determining the distance between the respective objects 1147 or position marking indicators 1148 and communicating the determined distance to the controller 1114, or the sensing device 1118 may provide signals to the controller 1114 to be used by the controller 1114 to determine the distance of the spacing between the objects 1147 or position marking indicators 1148.

Furthermore, vehicle 1100 includes a telematics unit 1135. Operatively coupled to the telematics unit 1135 is a network connection or vehicle bus 1136. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 1136 enables the vehicle 1100 to send and receive signals from the telematics unit 1135 to various units of equipment and systems both outside the vehicle 1100 and within the vehicle 1100 to perform various functions, such as communicating with the “cloud”-type data storage system described above. The telematics unit 1135 generally includes an electronic processing device 1137 operatively coupled to one or more types of electronic memory 1138, a cellular chipset/component 1139, a wireless modem 1140, a navigation unit containing a location detection (e.g., global positioning system (GPS)) chipset/component 1141, a real-time clock (RTC) 1142, a short-range wireless communication network 1143 (e.g., a Bluetooth® unit), and/or a dual antenna 1144.

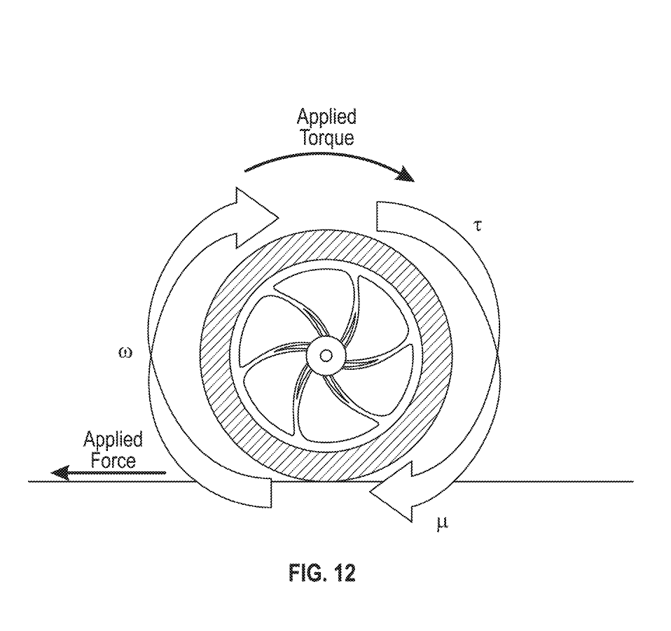

With reference now back to FIG. 1, and in particular block 110, based on the active testing performed as described above in accordance with blocks 107-109, an evaluation of the test results may be performed to determine a surface mu. Various calculation methodologies are known in the art. For example, FIG. 12 is an illustration pertaining to the measurement and calculation of the surface mu based on applied and measured variables as follows (note that sign changes are required for positive/negative torque):

Just Before Slip:

$${F}_{Applied} = \frac{τ}{{r}_{tire}}$$

$${F}_{Friction} = {F}_{Normal} * μ$$

$$μ = \frac{τ}{{F}_{Normal} * {r}_{tire}}$$

While Slipping or Recovering:

$$τ = I α = I \dot{ω} = \frac{\dot{v}}{{r}_{tire}}$$

$$\frac{I \dot{v}}{{r}^{2}} = {F}_{Normal} * μ$$

$$μ = \frac{I \dot{v}}{{F}_{Normal} * {r}_{tire}^{2}}$$

In any case, it is expected that the physics of tire friction on a surface, and the rotational physics of wheels, should be well-understood by those having ordinary skill in the art. Thus, based on the testing procedures described in detail above, and the physical measurements obtained thereby, it is expected that the person having ordinary skill in the art will be able to use basic principles of physics to derive a surface mu in a suitable manner, whether or not according to the equations set forth above in connection with FIG. 12.

As pertains to the making of the aforementioned calculations, and more generally as pertains to data processing in connection with all steps of method 100, a suitable vehicle will be equipped with one or more computer processors. Such processor may be implemented or realized with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. The processor includes non-transitory memory such as on-board RAM (random access memory) and on-board ROM (read-only memory). The program instructions that control the processor may be stored in either or both the RAM and the ROM. For example, in just one possible example, operating system software may be stored in the ROM, whereas various operating mode software routines and various operational parameters may be stored in the RAM. It will be appreciated that this is merely exemplary of one scheme for a processor, and that various others may alternatively or additionally be implemented.

With continued reference to FIG. 1, the results of the test performed, or if confidence was high and no test was performed, the result of the surface mu estimation, or both, may be used in connection with control of the vehicle based upon a revised estimate of its performance capability (block 111). For example, for a low surface mu, the speed of the vehicle may be reduced prior to turning, driving on a bridge, exiting on a ramp, driving through a parking lot, and the like. That is, the vehicle performance capability estimate is lowered so as to achieve a greater margin for safety at and near the locale. Moreover, alternate routes may be devised to avoid low surface mu locales. Otherwise, where the surface mu is estimated/determined to be high, vehicle operations may be conducted assuming normal performance capability.

As an additional matter, it should be noted that block 112 references the sending of information regarding surface mu confidence and evaluated (tested) surface mu to a “cloud”-type storage. As previously mentioned, this type of storage may be used in connection with a fleet of vehicles that may, from time to time, travels over the same or similar paths. Thus, the results of any active invasive testing may be transmitted to the cloud storage system as discussed above, for use in other fleet vehicle evaluations, or for providing information to other fleet vehicles that will allow them to choose alternate/better paths to travel.

Accordingly, the present disclosure illustrates the use of a heuristic algorithm to collect information from various sources that by themselves do not have sufficient integrity to make driving decisions on, but when collected and processed together these signals can result in better information. However when the information is still not sufficient, but hints at trends that may cause a reduction of vehicle capability due to reduction of surface mu, an active invasive test may be scheduled with the goal to test the hypothesis of reduction of surface mu. Thus, the present disclosure beneficially adds vehicle safety during possible reduced capability driving conditions, which enables the expansion of use cases for autonomous driving, which in turn adds to customer satisfaction.

While at least one exemplary system and methodology for the determination of a coefficient of friction has been presented in the foregoing detailed description, it should be appreciated that a vast number of variations exist. It should also be appreciated that the exemplary systems and methodologies for the determination of a coefficient of friction are only examples, and are not intended to limit the scope, applicability, or configuration of the disclosure in any way. Rather, the foregoing detailed description will provide those skilled in the art with a convenient road map for implementing an exemplary flexible pouch assembly of the disclosure. It is understood that various changes may be made in the function and arrangement of elements described in exemplary systems and methodologies for the determination of a coefficient of friction without departing from the scope of the disclosure as set forth in the appended claims.

1. A method for active dynamic testing to determine a coefficient of friction between a vehicle wheel and a surface with which the vehicle wheel is in contact (“surface mu”), the method comprising the steps of:
calculating a surface mu confidence level based upon an evaluation of a locale of interest for surface mu determination and at least one of: an evaluation of visual cues sensed by the vehicle at the locale of interest and an evaluation of vehicle signals at the locale of interest;
based upon a calculated relatively low surface mu confidence level, scheduling the vehicle to perform active dynamic testing at the locale of interest;
based upon the scheduling, performing the active dynamic testing, wherein the testing comprises commanding the vehicle to perform one or more of propulsion torqueing, regenerative torqueing, or brake torqueing of at least one wheel of the vehicle;
receiving at least one measured parameter from the at least one wheel during said testing; and
based on the at least one measured parameter, calculating a surface mu value for the locale of interest.

2. The method of claim 1, wherein the vehicle comprises an autonomous drive control system and is capable of operating without intervention by a human operator.

3. The method of claim 1, wherein the evaluation of the locale of interest comprises receiving a report from another vehicle regarding the surface mu at the locale of interest, the report being obtained via a cloud-type data storage system accessible by a plurality of vehicles in a fleet.

4. The method of claim 1, wherein the evaluation of the locale of interest comprises obtaining a weather report for the locale of interest or determining a road surface type for the locate of interest.

5. The method of claim 1, wherein the evaluation of visual cues comprises detecting a visual sensor obstruction, or detecting either a white road surface condition or a shiny road surface condition.

6. The method of claim 1, wherein the evaluation of vehicle signals comprises detecting one or more of rain through a rain detection sensor, windshield wiping, outside air temperature, outside humidity, and tire air temperature.

7. The method of claim 1, wherein the relatively low surface mu confidence level is calculated based upon the vehicle having traveled a predetermined distance since a previous surface mu determination and there exists a suspicion of relatively low surface mu based upon one or more of the evaluation of the locale of interest, the evaluation of the vehicle signals, and the evaluation of the visual cues.

8. The method of claim 1, prior to scheduling the vehicle, making one or more of a testing safety determination and a testing opportuneness determination.

9. The method of claim 1, wherein the propulsion torqueing is performed either while the vehicle is in motion, or while the vehicle is at a standstill with or without non-drive-wheel brakes engaged.

10. The method of claim 1, wherein the brake torqueing is performed while the vehicle is in motion by applying an increasing amount of torque to either or both of the rear wheels of the vehicle, with the proviso that braking torque need only be applied to one vehicle rear wheel.
